(19) United States
(12) Patent Application Publication
(10) Pub. No.: US 2003/0166357 A1
(43) Pub. Date: Sep. 4, 2003

(54) Bulb socket of a lighting string

(76) Inventor: Jeou-Nan Tseng, Hsinchu (TW)

Correspondence Address: Jackson Walker L.L.P., Suite 2100, 112 E. Pecan Street, San Antonio, TX, 78205, US

(21) Appl. No.: 10/090,332

(22) Filed: Mar. 4, 2002

(51) Int. Cl. H01R 4/24

(52) U.S. Cl. 439/419

(57) ABSTRACT

A bulb socket of a lighting string has a hollow body. A bore is defined in the body to receive a light bulb. A groove is defined in a lateral surface defining the bore to receive a lateral piece made of a conductive material. A ridge is formed in the groove and extends along a longitudinal direction of the groove. At least one wing extends from a side of the lateral piece so that while the lateral piece is received in the groove the wings further extend deep into the groove to secure the lateral piece in place. Therefore, the lateral piece is prevented from falling out of the groove undesirably.

### BACKGROUND OF THE INVENTION

1. Field of the Invention

The present invention relates to the field of lighting strings, and more particularly to a bulb socket of a lighting string.

2. Description of Related Art

A lighting string is commonly used during Christmas seasons to provide decorative effects. The lighting string has a lot of light bulbs respectively plugged to the bulb sockets to be electrically connected with wires of the lighting string. Therefore, the lighting string can be placed onto a Christmas tree, a door or a window while the light bulbs twinkle so as to provide the decorative effects.

With reference to FIGS. 8 and 9, a conventional bulb socket has a cylindrical hollow body (70). A cap (80) is mounted under the body (70) and two wires (90) are sandwiched between a bottom surface of the body (70) and the cap (80). A bore (72) is defined in the body (70) to receive a light bulb (99) (shown in phantom line in FIG. 8). A groove (74) is defined in an inner surface defining the bore (72). A slot (76) is defined in a bottom surface defining the bore (72). A hole (742) is defined through the bottom surface defining the bore (72) and adjacent to the groove (74).

With reference to FIGS. 9 and 10, a lateral piece (78) made of a conductive material is received in the groove (74) and has a sharp point (782) extending through the bottom surface defining the bore (72) via the hole (742) to penetrate one of the wires (90) for connecting with a copper filament inside that wire (90). An arcuate bottom piece (79) made of the conductive material is received in the slot (76) and also has a sharp point (792) extending through the bottom surface defining the bore (72) to penetrate the other wire (90) for connecting with a copper filament inside this wire (90). Therefore, when the light bulb (99) is plugged into the bulb socket, a base (not shown) of the light bulb (99) is received in the bore (72) and conductive contacts of the base respectively engage the lateral piece (78) and the bottom piece (79) so as to electrically connect the light bulb (99) with the wires (90).

However, the lateral piece (78) is merely received in the groove (74) without being properly secured. Surely, when the light bulb (99) is plugged into the bulb socket, the lateral piece (78) is restricted by the base of the light bulb (99), but once the light bulb (99) is taken out of the socket, the lateral piece (78) is very likely to fall out of the groove (74). Apparently, if the lateral piece (78) is not in place, the light bulb (99) later received in the bulb socket cannot operate normally.

To overcome the shortcomings, the present invention intends to provide a bulb socket of a lighting string to mitigate and obviate the aforementioned problems.

### SUMMARY OF THE INVENTION

The primary objective of the present invention is to provide a bulb socket of a lighting string such that a lateral piece and a groove defined to receive the lateral piece are specially designed so that the lateral piece can be conveniently yet securely received in the groove.

Another objective of the present invention is to provide a bulb socket of a lighting string such that a boss is formed on the lateral piece to enhance the conductivity between the lateral piece and a light bulb.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a bulb socket of a lighting string in accordance with the present invention;

FIG. 2 is an exploded, perspective view of the bulb socket, wherein a first preferred embodiment of a lateral piece is shown;

FIG. 3 is a perspective view of the first preferred embodiment of the lateral piece;

FIG. 4 is a top view of the bulb socket, wherein the first preferred embodiment of the lateral piece in FIG. 3 is shown;

FIG. 5 is another exploded, perspective view of the bulb socket, wherein a second preferred embodiment of the lateral piece is shown;

FIG. 6 is a top view of the bulb socket, wherein the second preferred embodiment of the lateral piece in FIG. 5 is shown;

FIG. 7 is another perspective view of the first preferred embodiment of the lateral piece, wherein a boss shown in FIG. 3 is replaced by protrusions;

FIG. 8 is a perspective view of a conventional bulb socket;

FIG. 9 is an exploded, perspective view of the conventional bulb socket; and

FIG. 10 is a top view of the conventional bulb socket in FIG. 8.

### DETAILED DESCRIPTION OF THE PREFERRED EMBODIMENT

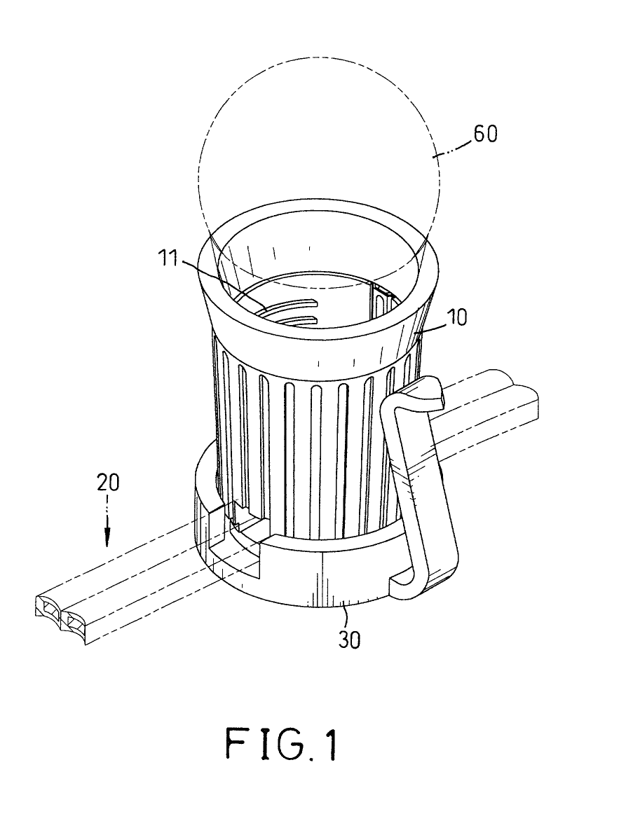

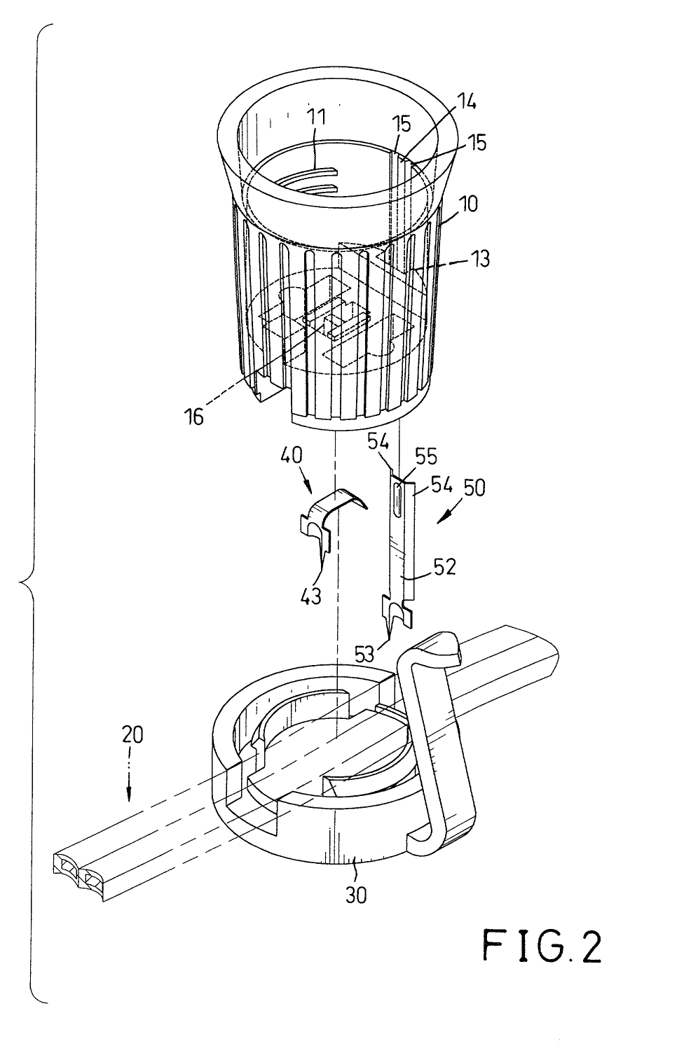

With reference to FIGS. 1 and 2, a bulb socket of a lighting string in accordance with the present invention has a hollow body (10) and a cap (30) mounted under the body (10) to sandwich wires (20) of the lighting string between a bottom surface of the body (10) and the cap (30). The body (10) has a bore (11) defined to receive a light bulb (60). Two grooves (15) are defined in a lateral surface defining the bore (11). A trapezoidal ridge (14) is thus formed between the grooves (15) and extends along a longitudinal direction in the body (10). A slot (16) is defined in the bottom surface defining the bore (11). A hole (13) is defined through the bottom surface defining the bore (11) and adjacent to the grooves (15).

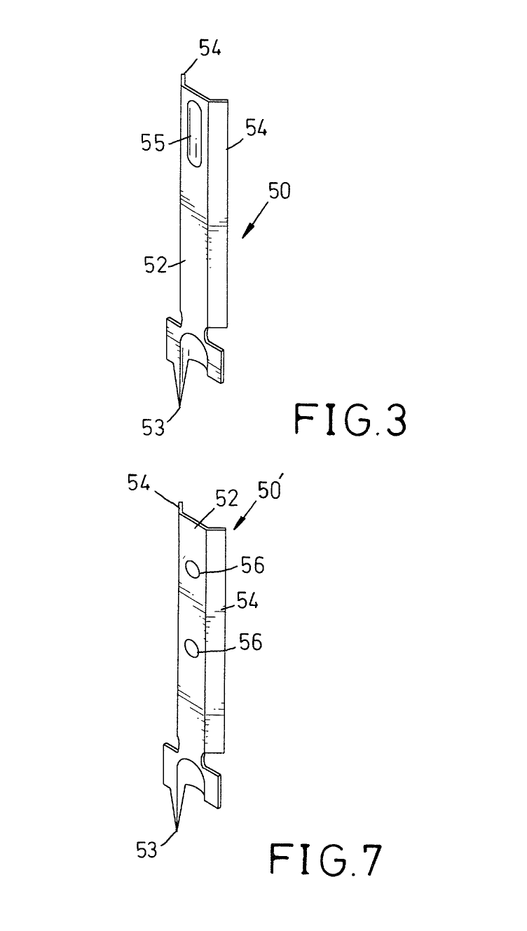

With reference to FIGS. 2, 3 and 4, a first preferred embodiment of a lateral piece (50) made of a conductive material has a plate (52) and two wings (54) integrally extending from two sides of the plate (52). The plate (52) and the wings (54) together form a shape substantially the same as that of the grooves (15) and the ridge (14). A sharp point (53) is formed at an end of the lateral piece (52). A slender boss (55) is formed near the other end of the lateral piece (52). Furthermore, an arcuate bottom piece (40) has a configuration to correspond to the slot (16) and a sharp point (43) formed at an end of the bottom piece (40). However, the bottom piece (40) is also made of the conductive material and similar to conventional articles of the like and is not the focus of this invention. Therefore, excessive description pertaining to the bottom piece (40) is omitted.

In assembly of the bulb socket, the lateral piece (50) is snugly fitted in the grooves (15) while the wings (54) extend deep into the grooves (15). Moreover, the sharp end (53) of the lateral piece (50) extends through the bottom surface defining the bore (11) via the hole (13) to penetrate one of the wires (20) for connecting with a copper filament inside that wire (90). The bottom piece (40) is received in the slot (16) and also has a sharp point (43) extending through the bottom surface defining the bore (11) to penetrate the other wire (20) for connecting with a copper filament inside this wire (20). Finally, the light bulb (60) is plugged to the bulb socket, a base (not shown) of the light bulb (60) is received in the bore (11) and conductive contacts of the base respectively engage the lateral piece (50) and the bottom piece (40) so as to electrically connect the light bulb (60) with the wires (20).

It should be appreciated that the main characteristic of this invention is that because lateral piece (50) is snugly fitted in the grooves (15) while the wings (54) extend deep into the grooves (15), the lateral piece (50) is conveniently yet securely received in the groove (15). Therefore, even when the light bulb (60) is not plugged in the bulb socket or more specifically a base of the light bulb (60) is not received in the bore (11) to maintain the lateral piece (50) in place, the lateral piece (50) is still prevented from falling out of the groove (15).

It should be also appreciated that the boss (55) can increase the contact area between the lateral piece (50) and the base of the light bulb (60) if compared with a flat surface, and therefore, the conductivity between the lateral piece (50) and the base is enhanced.

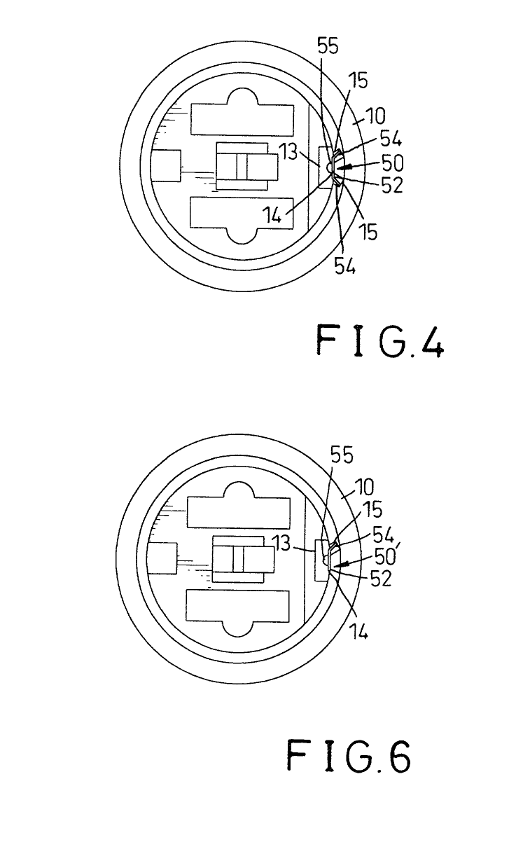

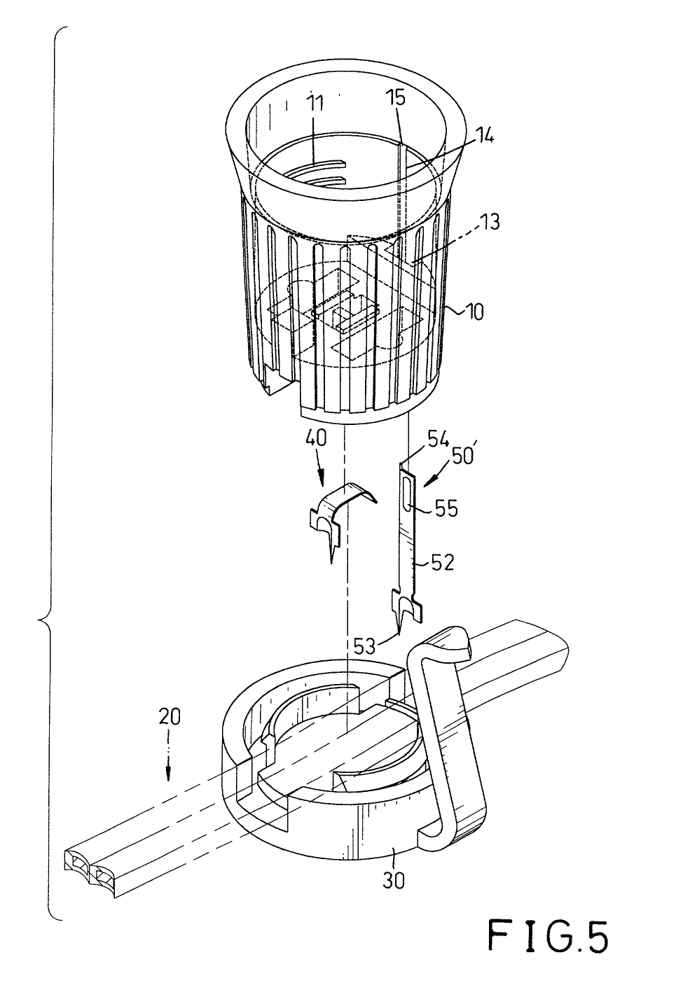

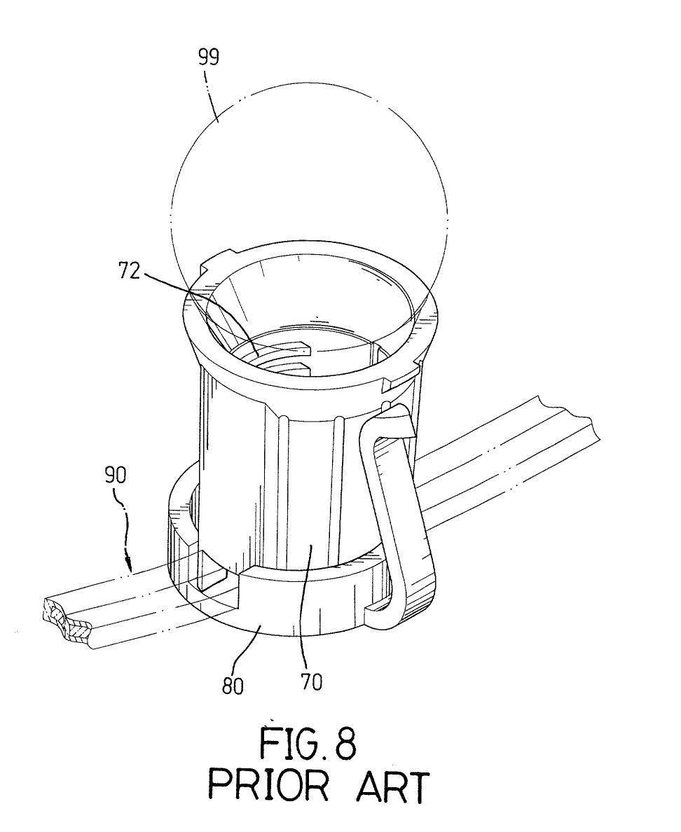

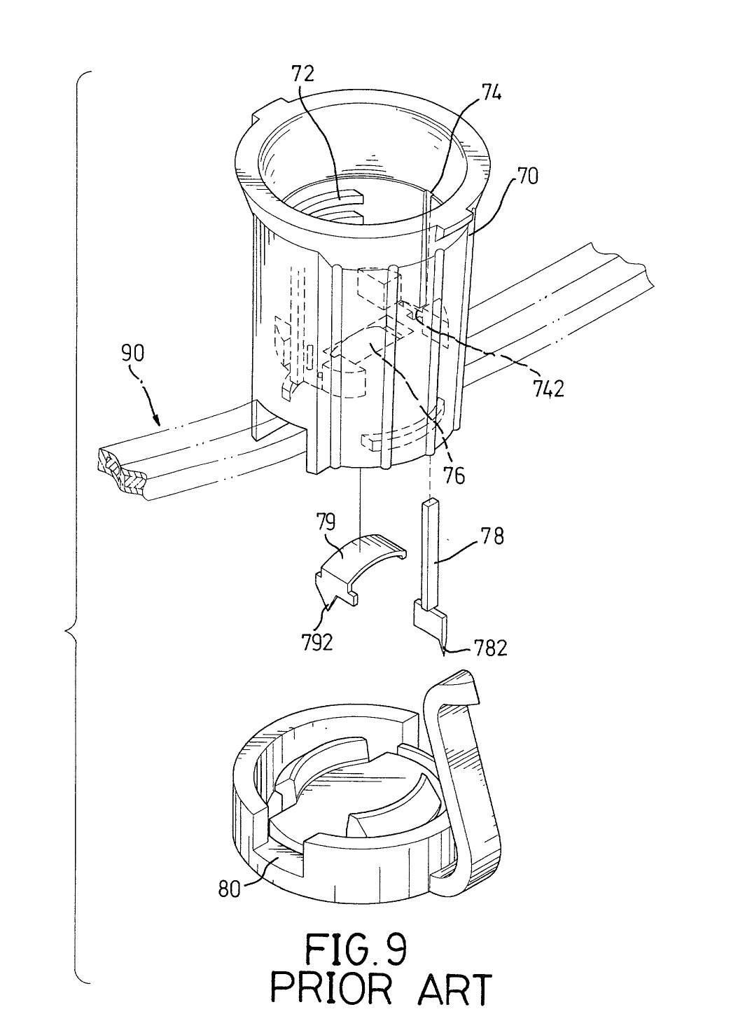

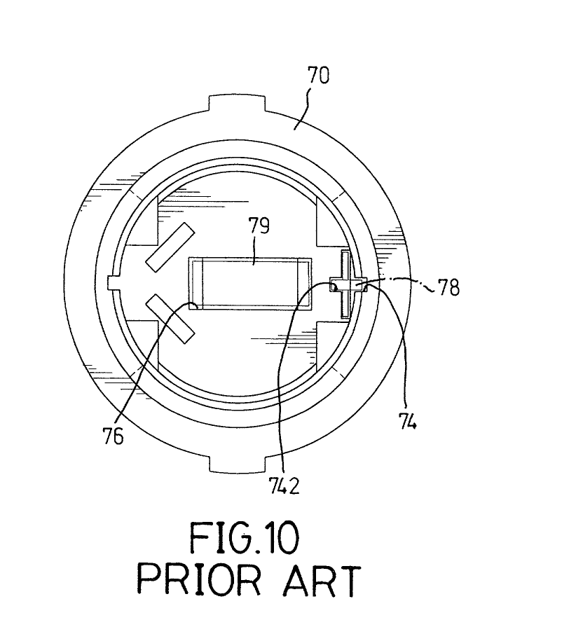

With reference to FIGS. 5, 6 and 7, a second preferred embodiment of the lateral piece (50′) is shown. In this preferred embodiment, the lateral piece (50′) has only one wing (54) extending from the plate (52). Accordingly, the groove (15) is modified in its configuration to mate the particular configuration of the second preferred embodiment of the lateral piece (50′). Furthermore, the boss (55) can also be changed to multiple protrusions (56) and still having the similar result, that is, to increase the contact area between the lateral piece (50) and the base of the light bulb (60) for enhancing the conductivity between the lateral piece (50) and the base.

While this invention has been particularly shown and described with references to the preferred embodiments thereof, it will be understood by those skilled in the art that various changes in form and details may be made therein without departing from the scope of the invention encompassed by the appended claims.

What is claimed is:

1. A bulb socket of a lighting string, the bulb socket having a hollow body and a cap mounted under the hollow body to sandwich wires of the lighting string, the hollow body having a bore defined to receive a light bulb, at least one groove defined in a lateral surface defining the bore and a slot defined in a bottom surface defining the bore, the bulb socket further having a bottom piece received in the slot and a lateral piece received in the groove, both of the pieces being electrically connected with the wires, wherein the improvements comprise:
the lateral piece having at least one wing extending from a side of the lateral piece to mate the at least one groove so as that the lateral piece is able to be securely received in the groove.

2. The light bulb socket as claimed in claim 1 further comprising a ridge formed in an inner face defining the bore.

3. The light bulb socket as claimed in claim 1 further comprising a boss formed on the lateral piece to be engaged with the light bulb for enhancing conductivity between the lateral piece and the light bulb.

4. The light bulb socket as claimed in claim 1 further comprising multiple protrusions formed on the lateral piece to be engaged with the light bulb for enhancing conductivity between the lateral piece and the light bulb.

5. The light bulb socket as claimed in claim 1, wherein two wings respectively extend from opposed sides of the lateral piece.

6. The light bulb socket as claimed in claim 2, wherein the ridge is in trapezoidal shape

7. The light bulb socket as claimed in claim 5, wherein two grooves are defined in an inner face defining the bore.

8. The light bulb socket as claimed in claim 6, wherein two grooves are defined in the inner face defining the bore.
